(19) United States
(12) Patent Application Publication
(10) Pub. No.: US 2021/0329891 A1
(43) Pub. Date: Oct. 28, 2021

(54) DYNAMIC LASER SYSTEM RECONFIGURATION FOR PARASITE CONTROL

(71) Applicant: Ecto, Inc., Atlanta, GA (US)

(72) Inventors: Dmitry Kozachenok, Atlanta, GA (US); Allen Torng, Atlanta, GA (US)

(21) Appl. No.: 16/858,773

(22) Filed: Apr. 27, 2020

(51) Int. Cl. A01K 61/13; A01K 29/00

(52) U.S. Cl. CPC A01K 61/13; A01K 29/005

(57) ABSTRACT

A method of dynamically reconfiguring laser system operating parameter by receiving, at an electronic device, data indicative of one or more underwater object parameters corresponding to one or more underwater objects within a marine enclosure. A set of intrinsic operating parameters for a laser system at a position within the marine enclosure is determined based at least in part on the data indicative of one or more underwater object parameters. The laser system is configured according to the determined set of intrinsic operating parameters by changing at least one intrinsic operating parameter of the laser system in response to the data indicative of one or more underwater object parameters.

### BACKGROUND

Industrial food production is increasingly important in supporting population growth world-wide and the changing diets of consumers, such as the move from diets largely based on staple crops to diets that include substantial amounts of animal, fruit, and vegetable products. Precision farming technologies help increase the productivity and efficiency of farming operations by enabling farmers to better respond to spatial and temporal variabilities in farming conditions. Precision farming uses data collected by various sensor systems to enhance production systems and optimize farming operations, thereby increasing the overall quality and quantity of farmed products.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a system for implementing dynamic reconfiguration of laser systems in accordance with some embodiments.

FIG. 2 is a diagram illustrating a system for implementing dynamic reconfiguration of laser systems based on image data in accordance with some embodiments.

FIG. 3 is a diagram illustrating an example of dynamic reconfiguration of laser system operating parameters in accordance with some embodiments.

FIG. 4 is a flow diagram of a method for implementing dynamic reconfiguration of laser operating parameters in accordance with some embodiments.

FIG. 5 is a block diagram illustrating a system configured to provide dynamic reconfiguration of laser operating parameters in accordance with some embodiments.

### DETAILED DESCRIPTION

Farm operators in husbandry, including cultivation or production in agriculture and aquaculture industries, often deploy precision farming techniques including various sensor systems to help farmers monitor farm operations and to keep up with changing environmental factors. Observation sensors may allow a farmer the ability to identify individual animals, track movements, and other behaviors for managing farm operations. However, farm operators face several challenges in observing and recording data related to farm operations by nature of the environments in which husbandry efforts are practiced.

Aquaculture (which typically refers to the cultivation of fish, shellfish, and other aquatic species through husbandry efforts) is commonly practiced in open, outdoor environments and therefore exposes farmed animals, farm staff, and farming equipment to factors that are, at least partially, beyond the control of operators. Such factors include, for example, variable and severe weather conditions, changes to water conditions, turbidity, interference with farm operations from predators, and the like. Further, aquaculture stock is often held underwater and therefore more difficult to observe than animals and plants cultured on land. Conventional sensor systems are therefore associated with several limitations including decreased accessibility during certain times of the day or during adverse weather conditions.

Additionally, aquaculture stock is often subject to risk of commercial damage from parasite infestations due at least in part to the confining of fish in marine enclosures at unnaturally high densities (e.g., relative to wild fish) that make it easier for diseases to spread. For example, farms across the world commonly suffer from infestations of Lepeophtheirus salmonis, a sea louse that targets salmonids. Infected fish suffer in market value due to lesions that parasites can cause and also endanger health of fish; in extreme cases, an infestation can cause mass mortality. Monitoring and treatments, when necessary, should be carried out to ensure that parasites do not cause undue stress or damage to fish stock.

Common treatments for sea lice infestations have conventionally included harsh chemicals. Although chemical treatments are effective in managing sea lice outbreaks, the chemicals often have undesirable negative effects on the fish such as reducing appetite and growth. Further, sea lice are also beginning to develop a resistance to various classes of chemical treatments. Farms are beginning to use non-chemical treatments to augment or replace chemical treatments of sea lice infestations. One such non-chemical treatment includes shooting light pulses (e.g., lasers) at lice to optically kill lice.

However, as mentioned above, aquaculture is commonly practice in environments in which farmed animals and farming equipment (e.g., lice lasers) are, at least partially, beyond the control of operators. For example, environmental conditions are often variable in open-water environments such that the accuracy and performance of sensor and/or laser systems may vary under differing conditions. Further, systems that include physically guiding individual animals into position, such as into an imaging chamber, suffer from low throughput and sampling biases due to observation of fewer number of individuals.

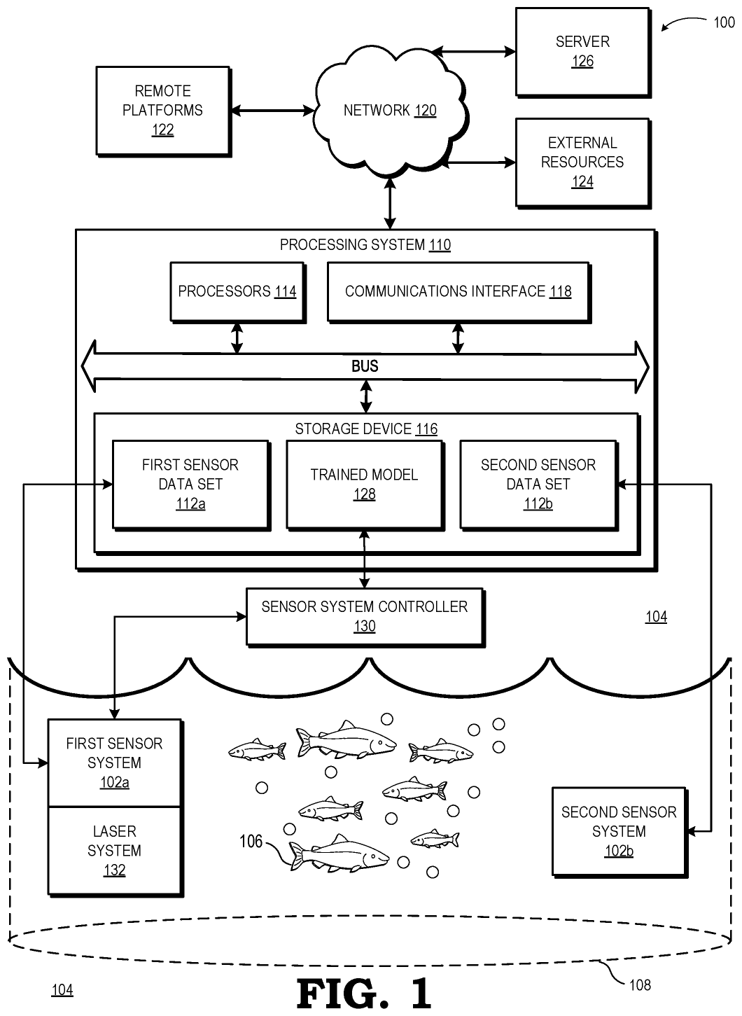

To improve the precision and accuracy of parasite control laser systems, FIGS. 1- 5 describe techniques for utilizing dynamic reconfiguration of laser system operating parameters during operations. In various embodiments, methods of dynamically reconfiguring laser system operating parameter include receiving, at an electronic device, data indicative of one or more underwater object parameters corresponding to one or more underwater objects within a marine enclosure. A set of intrinsic operating parameters for a laser system at a position within the marine enclosure is determined based at least in part on the data indicative of one or more underwater object parameters. The laser system is configured according to the determined set of intrinsic operating parameters by changing at least one intrinsic operating parameter of the laser system in response to the data indicative of one or more underwater object parameters.

Accordingly, as discussed herein, FIGS. 1-5 describe techniques that improve the precision and accuracy of laser systems by dynamically reconfiguring of laser system operating parameters during operations. In various embodiments, through the use of machine-learning techniques and neural networks, the systems described herein generate learned models that are unique to one or more intended use cases corresponding to different applications or activities at a farm site. Based on sensor data, the systems may use observed conditions at the farm sites to respond to environmental conditions/fish behavior relative to the laser systems and adjust laser system intrinsic operating parameters so that laser system operations are effective across various conditions and species without requiring physical repositioning of sensors.

FIG. 1 is a diagram of a system 100 for implementing dynamic reconfiguration of laser systems in accordance with some embodiments. In various embodiments, the system 100 includes one or more sensor systems 102 that are each configured to monitor and generate data associated with the environment 104 within which they are placed. In general, the one or more sensor systems 102 measure and convert physical parameters such as, for example, moisture, heat, motion, light levels, and the like to analog electrical signals and/or digital data.

As shown, the one or more sensor systems 102 includes a first sensor system 102a for monitoring the environment 104 below the water surface. In particular, the first sensor system 102a is positioned for monitoring underwater objects (e.g., a population of fish 106 as illustrated in FIG. 1) within or proximate to a marine enclosure 108. In various embodiments, the marine enclosure 108 includes a net pen system, a sea cage, a fish tank, and the like. Such marine enclosures 108 may include a circular-shaped base with a cylindrical structure extending from the circular-shaped base to a ring-shaped structure positioned at a water line, which may be approximately level with a top surface of the water surface.

In general, various configurations of an enclosure system may be used without departing from the scope of this disclosure. For example, although the marine enclosure 108 is illustrated as having a circular base and cylindrical body structure, other shapes and sizes, such as rectangular, conical, triangular, pyramidal, or various cubic shapes may also be used without departing from the scope of this disclosure. Additionally, the marine enclosure 108 in various embodiments is constructed of any suitable material, including synthetic materials such as nylon, steel, glass, concrete, plastics, acrylics, alloys, and any combinations thereof.

Although primarily illustrated and discussed here in the context of fish being positioned in an open water environment (which will also include a marine enclosure 108 of some kind to prevent escape of fish into the open ocean), those skilled in the art will recognize that the techniques described herein may similarly be applied to any type of aquatic farming environment and their respective enclosures. For example, such aquatic farming environments may include, by way of non-limiting example, lakes, ponds, open seas, recirculation aquaculture systems (RAS) to provide for closed systems, raceways, indoor tanks, outdoor tanks, and the like. Similarly, in various embodiments, the marine enclosure 108 may be implemented within various marine water conditions, including fresh water, sea water, pond water, and may further include one or more species of aquatic organisms.

As used herein, it should be appreciated that an underwater “object” refers to any stationary, semi-stationary, or moving object, item, area, or environment in which it may be desirable for the various sensor systems described herein to acquire or otherwise capture data of. For example, an object may include, but is not limited to, one or more fish 106, crustacean, feed pellets, predatory animals, and the like. However, it should be appreciated that the sensor measurement acquisition and analysis systems disclosed herein may acquire and/or analyze sensor data regarding any desired or suitable “object” in accordance with operations of the systems as disclosed herein. Further, it should be recognized that although specific sensors are described below for illustrative purposes, various sensor systems may be implemented in the systems described herein without departing from the scope of this disclosure.

In various embodiments, the first sensor system 102a includes one or more observation sensors configured to observe underwater objects and capture measurements associated with one or more underwater object parameters. Underwater object parameters, in various embodiments, include one or more parameters corresponding to observations associated with (or any characteristic that may be utilized in defining or characterizing) one or more underwater objects within the marine enclosure 108. Such parameters may include, without limitation, physical quantities which describe physical attributes, dimensioned and dimensionless properties, discrete biological entities that may be assigned a value, any value that describes a system or system components, time and location data associated with sensor system measurements, and the like.

For ease of illustration and description, FIG. 1 is described here in the context of underwater objects including one or more fish 106. However, those skilled in the art will appreciate that the marine enclosure 108 may include any number of types and individual units of underwater objects. For embodiments in which the underwater objects include one or more fish 106, an underwater object parameter includes one or more parameters characterizing individual fish 106 and/or an aggregation of two or more fish 106. As will be appreciated, fish 106 do not remain stationary within the marine enclosure 108 for extended periods of time while awake and will exhibit variable behaviors such as swim speed, schooling patterns, positional changes within the marine enclosure 108, density of biomass within the water column of the marine enclosure 108, size-dependent swimming depths, food anticipatory behaviors, and the like.

In some embodiments, an underwater object parameter with respect to an individual fish 106 encompasses various individualized data including but not limited to: an identification (ID) associated with an individual fish 106, movement pattern of that individual fish 106, swim speed of that individual fish 106, health status of that individual fish 106, distance of that individual fish 106 from a particular underwater location, detection of one or more parasites on an individual fish 106, and the like. In some embodiments, an underwater object parameter with respect to two or more fish 106 encompasses various group descriptive data including but not limited to: schooling behavior of the fish 106, average swim speed of the fish 106, swimming pattern of the fish 106, physical distribution of the fish 106 within the marine enclosure 108, and the like.

A processing system 110 receives data generated by the one or more sensor systems 102 (e.g., sensor data sets 112) for storage, processing, and the like. As shown, the one or more sensor systems 102 includes a first sensor system 102a having one or more sensors configured to monitor underwater objects and generate data associated with at least a first underwater object parameter. Accordingly, in various embodiments, the first sensor system 102a generates a first sensor data set 112a and communicates the first sensor data set 112a to the processing system 110. In various embodiments, the one or more sensor systems 102 includes a second sensor system 102b positioned proximate the marine enclosure 108 and configured to monitor the environment 104 within which one or more sensors of the second sensor system 102b are positioned. Similarly, the second sensor system 102b generates a second sensor data set 112b and communicates the second sensor data set 112 to the processing system 110.

In some embodiments, the one or more sensors of the second sensor system 102b are configured to monitor the environment 104 below the water surface and generate data associated with an environmental parameter. In particular, the second sensor system 102b of FIG. 1 includes one or more environmental sensors configured to capture measurements associated with the environment 104 within which the system 100 is deployed. In various embodiments, the environmental sensors of the second sensor system 102b include one or more of a turbidity sensor, a pressure sensor, a dissolved oxygen sensor, an ambient light sensor, a temperature sensor, a salinity sensor, an optical sensor, a motion sensor, a current sensor, and the like. For example, in one embodiment, the environmental sensors of the second sensor system 102b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). As described in further detail below, in various embodiments, the environmental sensors of the second sensor system 102b generate environmental data that serves as reference data for implementing the dynamic reconfiguration of laser system operating parameters.

In various embodiments, the one or more sensor systems 102 are communicably coupled to the processing system 110 via physical cables (not shown) by which data (e.g., sensor data sets 112) is communicably transmitted from the one or more sensor systems 102 to the processing system 110. Similarly, the processing system 110 is capable of communicably transmitting data and instructions via the physical cables to the one or more sensor systems 102 for directing or controlling sensor system operations. In other embodiments, the processing system 110 receives one or more of the sensor data sets 112 (e.g., first sensor data set 112a and the environmental sensor data set 112b) via, for example, wired-telemetry, wireless-telemetry, or any other communications link for processing, storage, and the like.

The processing system 110 includes one or more processors 114 coupled with a communications bus (not shown) for processing information. In various embodiments, the one or more processors 114 include, for example, one or more general purpose microprocessors or other hardware processors. By way of non-limiting example, in various embodiments, the processing system 110 may be any computer system, such as a workstation, desktop computer, server, laptop, handheld computer, tablet computer, mobile computing or communication device, or other form of computing or telecommunications device that is capable of communication and that has sufficient processor power and memory capacity to perform the operations described herein.

The processing system 110 also includes one or more storage devices 116 communicably coupled to the communications bus for storing information and instructions. In some embodiments, the one or more storage devices 116 includes a magnetic disk, optical disk, or USB thumb drive, and the like for storing information and instructions. In various embodiments, the one or more storage devices 116 also includes a main memory, such as a random-access memory (RAM), cache and/or other dynamic storage devices, coupled to the communications bus for storing information and instructions to be executed by the one or more processors 114. The main memory may be used for storing temporary variables or other intermediate information during execution of instructions to be executed by the one or more processors 114. Such instructions, when stored in storage media accessible by the one or more processors 114, render the processing system 110 into a special-purpose machine that is customized to perform the operations specified in the instructions.

The processing system 110 also includes a communications interface 118 communicably coupled to the communications bus. The communications interface 118 provides a multi-way data communication coupling configured to send and receive electrical, electromagnetic or optical signals that carry digital data streams representing various types of information. In various embodiments, the communications interface 118 provides data communication to other data devices via, for example, a network 120.

Users may access system 100 via remote platform(s) 122. For example, in some embodiments, the processing system 110 may be configured to communicate with one or more remote platforms 122 according to a client/server architecture, a peer-to-peer architecture, and/or other architectures via the network 120. The network 120 may include and implement any commonly defined network architecture including those defined by standard bodies. Further, in some embodiments, the network 120 may include a cloud system that provides Internet connectivity and other network-related functions. Remote platform(s) 122 may be configured to communicate with other remote platforms via the processing system 110 and/or according to a client/server architecture, a peer-to-peer architecture, and/or other architectures via the network 120.

A given remote platform 122 may include one or more processors configured to execute computer program modules. The computer program modules may be configured to enable a user associated with the given remote platform 122 to interface with system 100, external resources 124, and/or provide other functionality attributed herein to remote platform(s) 122. External resources 124 may include sources of information outside of system 100, external entities participating with system 100, and/or other resources. In some implementations, some or all of the functionality attributed herein to external resources 124 may be provided by resources included in system 100.

In some embodiments, the processing system 110, remote platform(s) 122, and/or one or more external resources 124 may be operatively linked via one or more electronic communication links. For example, such electronic communication links may be established, at least in part, via the network 120. It will be appreciated that this is not intended to be limiting, and that the scope of this disclosure includes implementations in which the processing system 110, remote platform(s) 122, and/or external resources 124 may be operatively linked via some other communication media. Further, in various embodiments, the processing system 110 is configured to send messages and receive data, including program code, through the network 120, a network link (not shown), and the communications interface 118. For example, a server 126 may be configured to transmit or receive a requested code for an application program through via the network 120, with the received code being executed by the one or more processors 114 as it is received, and/or stored in storage device 116 (or other non-volatile storage) for later execution.

As previously described, the processing system 110 receives one or more sensor data sets 112 (e.g., first sensor data set 112a and the environmental sensor data set 112b) and stores the sensor data sets 112 at the storage device 116 for processing. In various embodiments, the sensor data sets 112 include data indicative of one or more conditions at one or more locations at which their respective sensor systems 102 are positioned. In some embodiments, the first sensor data set 112a includes sensor data indicative of, for example, movement of one or more objects, orientation of one or more objects, swimming pattern or swimming behavior of one or more objects, jumping pattern or jumping behavior of one or more objects, any activity or behavior of one or more objects, any underwater object parameter, and the like. In some embodiments, the environmental data set 112b includes environmental data indicating environmental conditions such as, for example, an ambient light level, an amount of dissolved oxygen in water, a water temperature level, a direction of current, a strength of current, a salinity level, a water turbidity, a water pressure level, a topology of a location, a weather forecast, and the like.

As will be appreciated, environmental conditions will vary over time within the relatively uncontrolled environment within which the marine enclosure 108 is positioned. Further, fish 106 freely move about and change their positioning and/or distribution within the water column (e.g., both vertically as a function of depth and horizontally) bounded by the marine enclosure 108 due to, for example, time of day, schooling patterns, resting periods, feeding periods associated with hunger, and the like. Accordingly, in various embodiments, the system 100 dynamically reconfigures operating parameters of a laser system 132 during operations, based at least in part on measured underwater object parameters and/or environmental conditions, and adapt laser system 132 operations to the varying physical conditions of the environment 104 and/or the fish 106. In this manner, the laser system 132 may be dynamically reconfigured to change its operating parameters for improving the effectiveness of laser system 132 operations across various conditions and fish 106 (and parasite) species without requiring a change in the physical location of the laser system 132. This is particularly beneficial for stationary laser systems 132 without repositioning capabilities or for reducing disadvantages associated with physically repositionable systems (e.g., more moving parts that increase possibilities of equipment malfunctions, disturbing the fish 106 which may negatively impact welfare and increase stress, and the like).

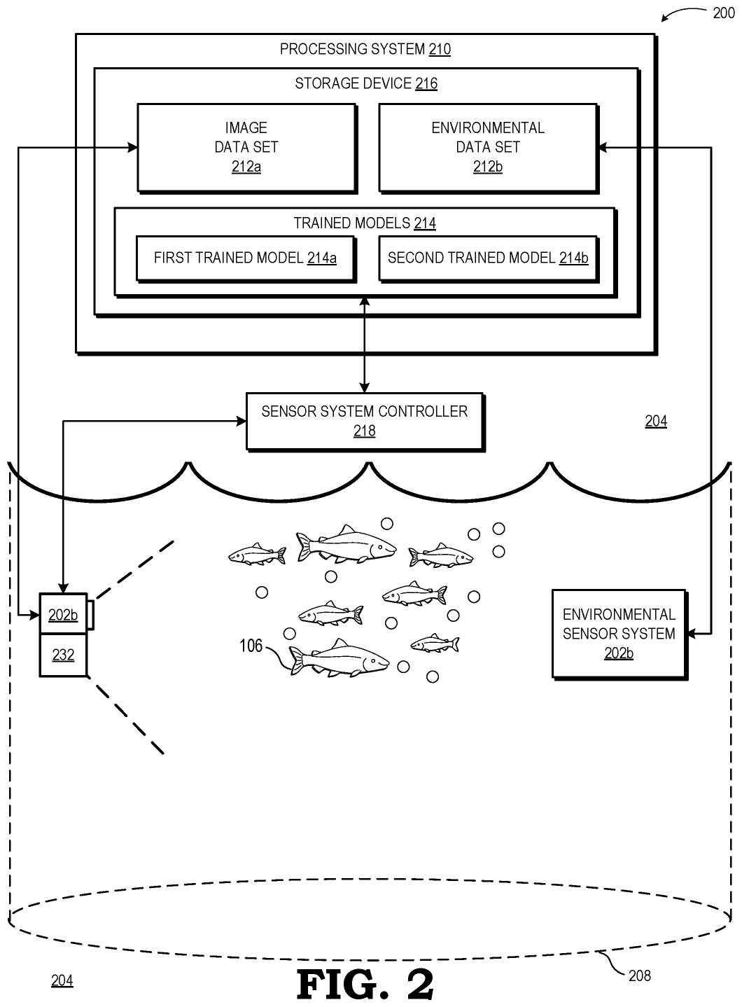

As described in more detail below with respect to FIGS. 2-5, the processing system 110 provides at least a portion of the sensor data 112 corresponding to underwater object parameters (e.g., first sensor data set 112a) and environmental conditions (e.g., environmental sensor data set 112b) as training data for generating a trained model 128 using machine learning techniques and neural networks. One or more components of the system 100, such as the processor 110 and a sensor system controller 130, may be periodically trained to improve the performance and accuracy of laser system 132 operations.

In particular, laser systems may be reconfigured in response to commands received from a computer system (e.g., processing system 110) for providing an efficient manner for automated and dynamic reconfiguration of laser systems to improve the results of aquaculture lice treatment operations. In various embodiments described herein, the dynamic sensor reconfiguration of intrinsic operating parameters is customized for particular environmental conditions, life cycles of parasites, species of parasites, and the like. For example, in one embodiment, obtained images from image sensors is used to monitor conditions in marine enclosures and identify parasites attached to fish 106 within the marine enclosure. The laser system 132 may be controlled based on image-identified positions of parasites in three-dimensional space to direct a light pulse (e.g., laser beam) towards the parasites to kill or otherwise disable the parasites.

As will be appreciated, it takes a certain amount of energy to deliver a fatal dose sufficient to kill parasites. It should also be appreciated that the fatal dose of light energy will vary on various factors including, but not limited to, a specific species of the parasite, a size of the parasite, a life cycle of the parasite, whether the parasite is attached to a fish 106 or is swimming unattached within the underwater environment 104, and the like. Additionally, the performance of underwater laser operations is often relatively sensitive to ambient conditions. Accordingly, because sensor systems 102 are capturing more relevant data for intended uses of a laser, the dynamic reconfiguring of laser system operating parameters during operations improves the results of aquaculture lice treatment operations. Further, by determining a proper fatal dose of light energy without under- or over-dosing, dynamic laser system reconfiguration improves energy efficiency by reducing an amount of instances in which a parasite needs to be re-lasered after previously receiving a non-lethal dose and/or delivering more energy than was needed to provide a lethal dose. This is particularly evident when considering the many thousands of pulses that may need to be administered per day, and further in view of the long time period that parasites should be kept under control before fish 106 are ready for harvest.

Referring now to FIG. 2, illustrated is a diagram showing a system 200 implementing dynamic reconfiguration of laser systems based on image data in accordance with some embodiments. In various embodiments, the system 200 includes one or more sensor systems 202 that are each configured to monitor and generate data associated with the environment 204 within which they are placed. In general, the one or more sensor systems 202 measure and convert physical parameters such as, for example, moisture, heat, motion, light levels, and the like to analog electrical signals and/or digital data.

As shown, the one or more sensor systems 202 includes a first image sensor system 202a including one or more cameras configured to capture still images and/or record moving images (e.g., video data). The one or more cameras may include, for example, one or more video cameras, photographic cameras, stereo cameras, or other optical sensing devices configured to capture imagery periodically or continuously. The one or more cameras are directed towards the surrounding environment 204, with each camera capturing a sequence of images (e.g., video frames) of the environment 204 and any objects in the environment.

In various embodiments, the one or more cameras of the first image sensor system 202a are configured to capture image data corresponding to, for example, the presence (or absence), abundance, distribution, size, and behavior of underwater objects (e.g., a population of fish 206 within a marine enclosure 208 as illustrated in FIG. 2). The system 200 may be used to monitor an individual fish, multiple fish, or an entire population of fish within the marine enclosure 208. Such image data measurements may, for example, be used to identify fish positions within the water. It should be recognized that although specific sensors are described below for illustrative purposes, various imaging sensors may be implemented in the systems described herein without departing from the scope of this disclosure.

In various embodiments, each camera (or lens) of the one or more cameras of the first image sensor system 202a has a different viewpoint or pose (i.e., location and orientation) with respect to the environment. Although FIG. 2 only shows a single camera for ease of illustration and description, persons of ordinary skill in the art having benefit of the present disclosure should appreciate that the first image sensor system 202a can include any number of cameras (or lenses) and which may account for parameters such as each camera's horizontal field of view, vertical field of view, and the like. Further, persons of ordinary skill in the art having benefit of the present disclosure should appreciate that the first image sensor system 202a can include any arrangement of cameras (e.g., cameras positioned on different planes relative to each other, single-plane arrangements, spherical configurations, and the like).

In some embodiments, the imaging sensors of the first image sensor system 202a includes a first camera (or lens) having a particular field of view as represented by the dashed lines that define the outer edges of the camera's field of view that images the environment 204 or at least a portion thereof. For the sake of clarity, only the field of view for a single camera is illustrated in FIG. 2. In various embodiments, the imaging sensors of the first image sensor system 202a includes at least a second camera having a different but overlapping field of view (not shown) relative to the first camera (or lens). Images from the two cameras therefore form a stereoscopic pair for providing a stereoscopic view of objects in the overlapping field of view. Further, it should be recognized that the overlapping field of view is not restricted to being shared between only two cameras. For example, at least a portion of the field of view of the first camera of the first image sensor system 202a may, in some embodiments, overlap with the fields of view of two other cameras to form an overlapping field of view with three different perspectives of the environment 204.

In some embodiments, the imaging sensors of the first image sensor system 202a includes one or more light field cameras configured to capture light field data emanating from the surrounding environment 204. In other words, the one or more light field cameras captures data not only with respect to the intensity of light in a scene (e.g., the light field camera's field of view/perspective of the environment) but also the directions of light rays traveling in space. In contrast, conventional cameras generally record only light intensity data. In other embodiments, the imaging sensors of the first image sensor system 202a includes one or more range imaging cameras (e.g., time-of-flight and LIDAR cameras) configured to determine distances between the camera and the subject for each pixel of captured images. For example, such range imaging cameras may include an illumination unit (e.g., some artificial light source) to illuminate the scene and an image sensor with each pixel measuring the amount of time light has taken to travel from the illumination unit to objects in the scene and then back to the image sensor of the range imaging camera.

It should be noted that the various operations are described here in the context of multi-camera configurations or multi-lens cameras. However, it should be recognized that the operations described herein may similarly be implemented with any type of imaging sensor without departing from the scope of this disclosure. For example, in various embodiments, the imaging sensors of the first image sensor system 202a may include, but are not limited to, any of a number of types of optical cameras (e.g., RGB and infrared), thermal cameras, range- and distance-finding cameras (e.g., based on acoustics, laser, radar, and the like), stereo cameras, structured light cameras, ToF cameras, CCD-based cameras, CMOS-based cameras, machine vision systems, light curtains, multi- and hyper-spectral cameras, thermal cameras, and the like. Such imaging sensors of the first image sensor system 202a may be configured to capture, single, static images and/or also video images in which multiple images may be periodically captured. In some embodiments, the first image sensor system 202a may activate one or more integrated or external illuminators (not shown) to improve image quality when ambient light conditions are deficient (e.g., as determined by luminosity levels measured by, for example, a light sensor falling below a predetermined threshold).

Additionally, as illustrated in FIG. 2, the one or more sensor systems 202 includes a second sensor system 202b positioned below the water surface and including a second set of one or more sensors. In various embodiments, the second set of one or more sensors include one or more environmental sensors configured to monitor the environment 204 below the water surface and generate data indicative of one or more environmental conditions associated with the marine enclosure 208. Although the second sensor system 202b is shown in FIG. 2 to be positioned below the water surface, those skilled in the art will recognize that one or more of the environmental sensors of the second sensor system 202b may be deployed under the water surface, at the water surface, above the water surface, remote to the locale at which the fish 206 are located, remote to the processing system 210, or any combination of the above without departing from the scope of this disclosure.

In various embodiments, the second sensor system 202b of FIG. 2 includes one or more environmental sensors configured to capture measurements associated with the environment 204 within which the system 200 is deployed. As described in further detail below, in various embodiments, the environmental sensors of the second sensor system 202b generate environmental data that serves as reference data for implementing the dynamic reconfiguration of sensor system operating parameters. Such environmental data may include any measurement representative of the environment 204 within which the environmental sensors are deployed.

For example, in various embodiments, the environmental data (and any data sets corresponding to the environmental data) may include, but is not limited to, any of a plurality of water turbidity measurements, water temperature measurements, metocean measurements, weather forecasts, air temperature, dissolved oxygen, current direction, current speeds, and the like. Further, the environmental parameters and environmental data may include any combination of present, past, and future (e.g., forecasts) measurements of meteorological parameters (e.g., temperature, wind speed, wind direction), water environment parameters (e.g., water temperature, current speed, current direction, dissolved oxygen levels, turbidity levels), air environment parameters, other environmental parameters, and the like. It should be recognized that although specific environmental sensors are described here for illustrative purposes, the second sensor system 202b may include any number of and any combination of various environmental sensors without departing from the scope of this disclosure.

In various embodiments, the processing system 210 receives one or more data sets 212 (e.g., image data set 212a and environmental data set 212b) and stores the data sets 212 at the storage device 216 for processing. In various embodiments, the data sets 212 include data indicative of one or more conditions at one or more locations at which their respective sensor systems 202 are positioned. For example, in some embodiments, the image data set 212a includes image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). With respect to image data, the image data set 212a may also include camera images capturing measurements representative of the relative and/or absolute locations of individual fish of the population of fish 206 within the environment 204. Such image data may be indicative of one or more underwater object parameters corresponding to one or more underwater objects (e.g., fish 206) within a marine enclosure 208. The image data may be indicative of, for example, movement of one or more objects, orientation of one or more objects, swimming pattern or swimming behavior of one or more objects, jumping pattern or jumping behavior of one or more objects, any activity or behavior of one or more objects, and the like.

It should be recognized that although the underwater object parameter has been abstracted and described here generally as “image data” for ease of description, those skilled in the art will understand that image data (and therefore the image data set 212a corresponding to the image data) may also include, but is not limited to, any of a plurality of image frames, extrinsic parameters defining the location and orientation of the image sensors, intrinsic parameters that allow a mapping between camera coordinates and pixel coordinates in an image frame, camera models, data corresponding to operational parameters of the image sensors (e.g., shutter speed), depth maps, and the like.

In some embodiments, the environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208. For example, in some embodiments, the environmental sensors of the second sensor system 202b includes an ambient light sensor or other photodetector configured to sense or otherwise measure an amount of ambient light present within the environment local to the sensor. In various embodiments, the environmental sensors of the second sensor system 202b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). In general, the more total suspended particulates or solids in water, the higher the turbidity and therefore murkier the water appears.

As will be appreciated, variable parameters corresponding to variance in underwater conditions in the environment 204 include, for example, variance in underwater object parameters (e.g., physical location of fish 206 within the marine enclosure 208 such as represented within image data set 212a) and variance in environmental parameters (e.g., the turbidity of a liquid medium such as represented within environmental data set 212b). Underwater conditions often vary and the accuracy of data gathered by different sensor systems will also vary over time.

Accurate image scene parsing is a crucial component for perception-related tasks in aquaculture. However, the variability of underwater objects and/or the environment will affect the accuracy of image-based measurements and accordingly the accuracy or reliability of any subsequent processes related to the image-based measurements (including human-based observations and assessments, machine-based processes which may consume the image data/image-based measurements as input, and the like). Accordingly, in various embodiments, image data (which in various embodiments includes at least a subset of image data captured by one or more cameras of the first image sensor system 202a) and environmental data (which in various embodiments includes at least a subset of environmental data captured by one or more environmental sensors of the second sensor system 202b) is provided as training data to generate trained models 214 using machine learning techniques and neural networks.

In various embodiments, the training data includes various images of underwater objects (e.g., fish 206) that are annotated or otherwise labeled with label instances (e.g., bounding boxes, polygons, semantic segmentations, instance segmentations, and the like) that identify, for example, individual fish, parasites in contact with the fish, feed pellets in the water, and various other identifiable features within imagery. For example, the training data may include various images of views of the underwater environment 204 and/or various images of fish 206, such as images of fish having varying features and properties, such as fins, tails, shape, size, color, and the like. The training data may also include images with variations in the locations and orientations of fish within each image, including images of the fish captured at various camera viewing angles. Further, in various embodiments, the training data also includes contextual image data (e.g., provided as image metadata) indicating, for example, one or more of lighting conditions, temperature conditions, camera locations, topology of the determined area, current direction or strength, salinity levels, oxygen levels, fish activities, and timing data at the time an image was captured.

Image data is often inhomogeneous due to, for example, variations in the image acquisition conditions due to illumination conditions, different viewing angles, and the like, which can lead to very different image properties such that such that objects of the same class may look very different. For example, in some embodiments, image variations arise due to viewpoint variations in which a single instance of an object can be oriented in various positions with respect to the camera. In some embodiments, image variations arise due to scale variations because objects in visual classes often exhibit variation in their size (i.e., not only in terms of their extent within an image, but the size of objects in the real world). In other embodiments, image variations arise due to deformation as various objects in visual classes are not rigid bodies and can be deformed in various manners. Further, in various embodiments, occlusions occur as objects of interest become positioned in space behind other objects such that they are not within the field of view of a camera and only a portion of an object is captured as pixel data.

Due to one or more of the variations discussed above, the degree of self-similarity between objects may often be quite low (referred to herein as intra-image variability) even within a single image. Similarly, image variations may also occur between different images of one class (referred to herein as intra-class variability). It is desirable to minimize intra-class variability as we want two objects of the same class to look quantitatively similar to a deep learning model. Further, in the context of underwater objects including the population of fish 206, it is desirable to increase inter-class variability such that images containing different species of fish to look different to a trained model, since they are in different categories/classes even though they are still fish.

Underwater image data, which is often captured in uncontrolled nature environments 204, is subject to large intra-class variation due to, for example, changing illumination conditions as the sun moves during the course of a day, changing fish 206 positions as they swim throughout the marine enclosure 208, changes in water turbidity due to phytoplankton growth, and the like. Discriminative tasks such as image segmentation should be invariant to properties such as incident lighting, fish size, distance of fish 206 from the camera, fish species, and the like. General purpose supervised feature learning algorithms learn an encoding of input image data into a discriminative feature space. However, as mentioned before, in natural scene data, it is often difficult to model inter-class variations (e.g., differentiation between species of fish 206) while being invariant to intra-class variability due to the naturally occurring extrinsic factors such as illumination, pose, and the like.

Accordingly, in various embodiments, the image training data utilizes prior data (referred to herein as metadata) to aid in object classification and image segmentation by correlating some of the observed intra-class variations for aiding discriminative object detection and classification. The metadata is orthogonal to the image data and helps address some of the variability issues mentioned above by utilizing extrinsic information, including metadata corresponding to intra-class variations, to produce more accurate classification results. Further, in some embodiments, the image training data may utilize image-level labels, such as for weakly supervised segmentation and determining correspondence between image-level labels and pixels of an image frame.

In various embodiments, metadata includes data corresponding to a pose of the first image sensor system 202a within the marine enclosure 208, such as with respect to its orientation, location, and depth within the water column. In some embodiments, metadata includes illumination condition information such as time of day and sun position information which may be used to provide illumination incidence angle information. Further, in some embodiments, the training data also includes metadata corresponding to human tagging of individual image frames that provide an indication as to whether an image frame meets a predetermined minimum quality threshold for one or more intended use cases. Such metadata allows trained models to capture one or more aspects of intra-class variations. It should be recognized that although specific examples of metadata are mentioned herein for illustrative purposes, various metadata may be utilized during model training for the systems described herein without departing from the scope of this disclosure.

In some embodiments, machine learning classifiers are used to categorize observations in the training image data. For example, in various embodiments, such classifiers generate outputs including one or more labels corresponding to detected objects. In various embodiments, the classifiers determines class labels for underwater objects in image data including, for example, a species of fish, a swimming pattern of a school of fish, a size of each fish, a location of each fish, estimated illumination levels, a type of activity that objects are engaged in, and the like. Classifiers may also determine an angle of a fish's body relative to a camera and/or identify specific body parts (e.g., deformable objects such as fish bodies are associated with a constellation of body parts), and at least a portion of each object may be partially occluded in the field of view of the camera.

In some embodiments, a classifier includes utilizing a Faster recurrent convolutional neural network (R-CNN) to generate a class label output and bounding box coordinates for each detected underwater object in an image. In other embodiments, a classifier includes utilizing a Mask R-CNN as an extension of the Faster R-CNN object detection architecture that additionally outputs an object mask (e.g., an output segmentation map) for detected underwater objects in an image and classifies each and every pixel within an image. In some embodiments, classifiers are utilized when image training data does not include any labeling or metadata to provide ground truth annotations. In other embodiments, classifiers are utilized to provide additional context or dimensionality to labeled data.

Additionally, in some embodiments, contextual data includes an identification of individual fish 206 in captured imagery. For example, fish 206 may be identified after having been tagged using, for example, morphological marks, micro tags, passive integrated transponder tags, wire tags, radio tags, RFID tags, and the like. In various embodiments, image analysis may be performed on captured image data to identify a unique freckle ID (e.g., spot patterns) of a fish 206. This freckle ID may correspond to a unique signature of the fish 206 and may be used to identify the fish 206 in various images over time.

Dynamic conditions, such as a change in the environment 204 around the first image sensor system 202a and/or the second sensor system 202b, impact the operations and accuracy of laser systems 232. For example, water quality can greatly influence aquaculture facilities located in the near coastal marine environment. Due to biotic and abiotic factors, these coastal settings exhibit large variability in turbidity or clarity throughout the water column. Similarly, the positions and distribution of fish 206 within the marine enclosure 208 will vary over time due to, for example, swimming pattern changes resulting from environmental factors such as temperature, lighting, and water currents, and timings of fish activities related to schooling, feeding, resting, and the like.

The transmission window of visible light through sea water is generally between 430-550 nm, which translates to blue (e.g., 430 nm) and green (e.g., 532 nm) wavelengths. Pulse energy can be altered to increase or decrease the laser fluence through seawater depending on conditions. However, organic and inorganic matter, phytoplankton, or other light scattering particulates can greatly increase laser attenuation even when using very high energy pulses. A shortened laser pulse width can be utilized to increase the amount of energy released over a desired period of time, and therefore increase the beam path travel distance. As the laser beam passes through the water column, beam spreading is likely occur due to scattering from particulate matter which leads the spot size of the laser to increase, effectively decreasing laser energy (W/m^2), and the ability of the laser to kill sea lice.

In various embodiments, machine learning techniques may be used to determine various relationships between training images and the contextual image data to learn or identify relationships (e.g., as embodied in the trained models 214) between sensor data (including image and/or environmental data) and laser operating parameters sufficient for administering lethal energy doses to parasites. For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more laser operating parameters.

In various embodiments, the trained models 214 include an output function representing learned laser system operating parameters. It should be recognized that the trained models 214 of system 200 may have multiple sensor operating parameters. It should be further recognized that the trained models 214, in various embodiments, include two or more trained models tailored to particular use cases, as laser system operating parameters in a vacuum independent of their intended uses may not be appropriate for a particular intended use. For example, a set of laser operating parameters for a first use case (e.g., killing a first species of parasites at a first farm location) may be wholly unsuitable for a second use case (e.g., killing a different species or size of parasites at a second farm location).

Accordingly, in some embodiments, the trained models 214 include a first trained model 214a for a first use case and at least a second trained model 214b for a second use case. As used herein, a “use case” refers to any specific purpose of use or particular objective intended to be achieved. For context purposes, in some embodiments, the first trained model 214a for the first use case may include a model trained to receive image sensor data and determine a first set of laser operating parameters for killing a first species of parasites. In some embodiments, the second trained model 214b for the second use case may include a model trained to receive image sensor data and determine a second set of laser operating parameters for killing a second species of parasites. In other words, the various trained models 214 are trained towards different target variables depending on the particular needs of their respective use cases.

By way of non-limiting example, in various embodiments, use cases for the embodiments described herein may include, but are not limited to, laser operating parameters for administering lethal doses of light energy to: different species of parasites, parasites attached to fish 106, parasites freely swimming in water, parasites at different life cycles, parasites attached to fish 106 of differing ages, parasites attached to fish 106 of differing health statuses, and the like. As will be appreciated, the characteristics of what represents a desirable set of laser operating parameters is dependent upon the specific use case. For example, a use case directed towards killing a first species of parasites (e.g., of a smaller size) may utilize operating parameters that are insufficient for killing a second species of parasites (e.g., of a larger size).

In various embodiments, the first trained model 214a may be trained to learn or identify a combination of intrinsic operating parameters for the laser system 232 that enables administering lethal doses of light energy for the first use case. Similarly, the second trained model 214b may be trained to learn or identify a combination of intrinsic operating parameters for the laser system 232 that enables administering lethal doses of light energy for the second use case.

As used herein, in various embodiments, “intrinsic parameters” or “intrinsic operating parameters” refers to parameters that define operations of an sensor or a laser that are independent of its position and/or orientation within a 3D scene (i.e., does not include rotational or translational movement of the sensor in 3D space).

In various embodiments, an intrinsic operating parameter of a laser system includes a wavelength of light emitted from the laser system 232. The color of light is determined by its frequency or wavelength. The shorter wavelengths are the ultraviolet and the longer wavelengths are the infrared. The smallest particle of light energy is described by quantum mechanics as a photon. The energy, E, of a photon is determined by its frequency, v, and Planck's constant, h. Generally, shorter wavelengths contain more energy per photon.

In various embodiments, an intrinsic operating parameter of a laser system includes laser power corresponding to energy output and/or a pulse width duration of laser pulses from the laser system 232. In various embodiments, the laser system 232 includes a pulsed laser. While the laser light of a continuous wave laser has a certain power, total energy output from a pulsed laser may be based on power, pulse energy, frequency, pulse width (duration), and the like.

In various embodiments, an intrinsic operating parameter of a laser system includes a mode of operation for the laser system 232. As mentioned above, a laser can be classified as operating in, for example, continuous or pulsed mode, depending on whether the power output is essentially continuous over time or whether its output takes the form of pulses of light on one or another time scale. Even a laser whose output is normally continuous can be intentionally turned on and off at some rate in order to create pulses of light.

It should be recognized although various specific examples of intrinsic operating parameters are discussed herein for illustrative purposes, various intrinsic operating parameters may be dynamically reconfigured during laser system 232 operations without departing from the scope of this disclosure. For example, in various embodiments, intrinsic operating parameters may further include, but are not limited to, a laser beam radius, a focal spot size, a focal length, a laser depth of focus, and the like.

As discussed above, in various embodiments, the trained models 214 include an output function representing learned laser system 232 operating parameters. Such trained models 214 may be utilized by, for example, a laser system controller 218 to dynamically reconfigure the intrinsic operating parameters of the laser system 232 with minimal operator input during operations. For example, in various embodiments, the first trained model 214a may be trained to learn or identify a combination of intrinsic operating parameters for the laser system 232 that enables killing a first species of parasites.

It should be appreciated that one or more of the various intrinsic operating parameters influence laser energy and effective distances; further, changing such intrinsic operating parameters relative to each other may have complementary or antagonistic effects on the amount of light energy ultimately administered, dependent upon various factors including but not limited to the prevailing underwater conditions (e.g., fish behavior/positioning as represented by underwater object parameters within image data set 212a and/or environmental factors as represented by environmental parameters within environmental data set 212b), the particular use case for captured image data is intended, and the like.

For example, visible red light has slightly more energy than invisible infrared radiation and is more readily absorbed by water than other visible wavelengths. Light with longer wavelengths is absorbed more quickly than that with shorter wavelengths. Because of this, higher energy light with short wavelengths (e.g., such as blue) is able to penetrate more deeply. For example, after 40 meters, saltwater will have absorbed nearly all the red visible light, yet blue light is still able to penetrate beyond that distance.

Accordingly, after receiving input data indicative of underwater conditions within or proximate to the marine enclosure 208 (e.g., including image data set 212a and/or environmental data set 212b), the first trained model 214a outputs a set of intrinsic operating parameters that is determined to provide an amount of light energy administration that is sufficient to kill a first species of parasites for its intended purposes in the first use case and under current prevailing conditions. In this manner, the dynamic sensor operating parameter reconfiguration of system 200 improves laser operations so that parasite control is effective across various conditions and species without requiring physical repositioning of sensors, which ultimately leads to increased yields and product quality.

In various embodiments, the laser system controller 218 instructs the laser system 232 to direct a light pulse according to the determined set of intrinsic operating parameters towards a parasite within the marine enclosure in response to re-configuring the laser system 232 according to the determined sensor intrinsic operating parameters. As will be appreciated, marine enclosures 208 are generally positioned in environments 204 within which the farmer operator has limited to no ability to manually influence extrinsic variations during parasite control operations. For example, the underwater farming environment 204 is generally not a controlled environment in which environmental conditions or underwater object behavior may be manually adjusted easily to create improved conditions for parasite control. For example, it is difficult to decrease water turbidity, coax fish 206 to swim within ideal distances of the laser system 232, and the like on command.

Accordingly, in various embodiments, while extrinsic sensor and laser parameters may be taken into account during analysis, the system 200 dynamically reconfigures intrinsic operating parameters without modifying extrinsic operating parameters. This is particularly beneficial for stationary systems 202 without repositioning capabilities and/or for reducing disadvantages associated with physically repositioning the lasers within the marine enclosure 208 (e.g., more moving parts that increase possibilities of equipment malfunctions, disturbing the fish 106 which may negatively impact welfare and increase stress, disrupting normal farm operations, and the like).

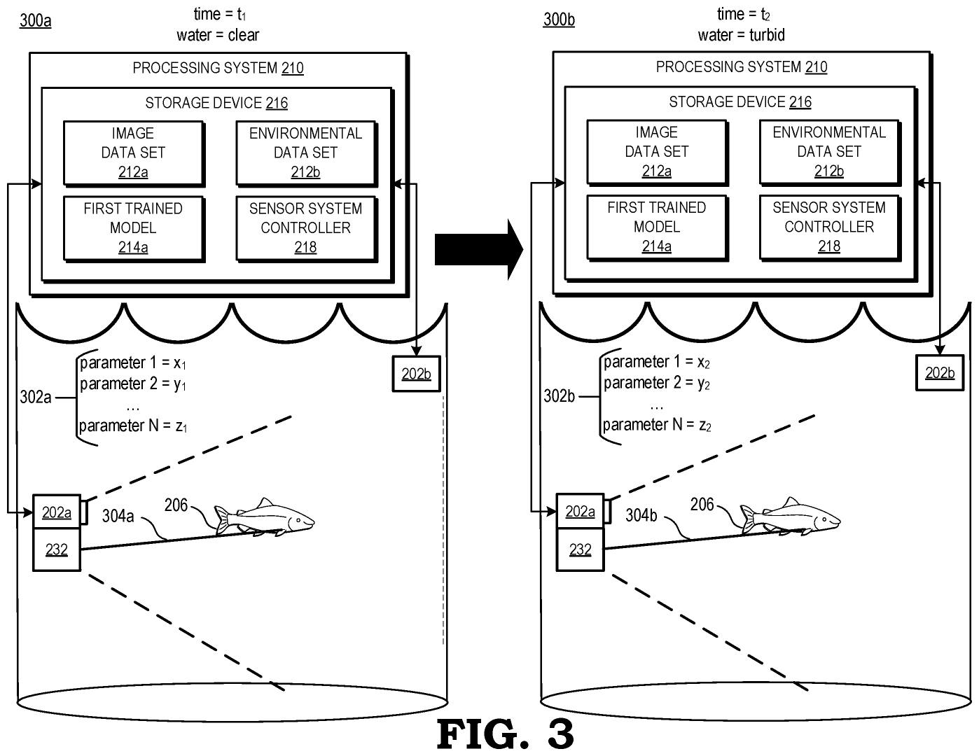

For context purposes, with respect to FIG. 3 and with continued reference to FIG. 2, illustrated is an example of dynamic intrinsic operating parameter reconfiguration of a laser system within underwater environment 204. As illustrated in the two panel views 300a and 300b, a first image sensor system 202a and a laser system 232 are positioned below the water surface and configured to capture still images and/or record moving images (e.g., video data). Although the first image sensor system 202a and the laser system 232 is shown in FIG. 3 to be positioned below the water surface, those skilled in the art will recognize that one or more cameras of the first image sensor system 202a may be deployed under the water surface, at the water surface, above the water surface, remote to the locale at which the fish 206 are located, remote to the processing system 210, or any combination of the above without departing from the scope of this disclosure. Further, although the laser system 232 is shown in FIG. 3 to be physically coupled to the first image sensor system 202a for ease of description, those skilled in the art will recognize that the laser system 232 may be deployed at any location within the marine enclosure.

The one or more cameras are directed towards the surrounding environment 204, with each camera capturing a sequence of images (e.g., video frames) of the environment 204 and any objects in the environment. In various embodiments, the one or more cameras monitor an individual fish, multiple fish, or an entire population of fish within the marine enclosure 208. Such image data measurements may, for example, be used to identify fish positions within the water.

In various embodiments, the processing system 210 receives one or more data sets 212 (e.g., image data set 212a and environmental data set 212b) and stores the data sets 212 at the storage device 216 for processing. In various embodiments, the data sets 212 include data indicative of one or more conditions at one or more locations at which their respective sensor systems 202 are positioned. For example, in some embodiments, the image data set 212a includes image data representing any image-related value or other measurable factor/characteristic that is representative of at least a portion of a data set describing the presence (or absence), abundance, distribution, size, and/or behavior of underwater objects (e.g., a population of fish 206 as illustrated in panel view 300a of FIG. 3). In various embodiments, the data sets 212 also include environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208.

In the context of FIG. 3, dynamic conditions, such as a change in the environment 204 around the first image sensor system 202a (e.g., due to movement of the fish 206 within the marine enclosure 208) and/or the second sensor system 202b, impact the operations and efficacy of the laser system 232. In particular, as illustrated in panel view 300a, a fish 206 is positioned within the marine enclosure 208 at a first time period t₁ at which the water is relatively clear of suspended particulates (e.g., as determined by environmental sensors 202b including a turbidity sensor). In panel view 300a, the laser system 232 is configured to operate according to a first set of intrinsic operating parameters 302a such that a first light pulse 304a emitted by the laser system 232 is sufficient to kill a parasite (not shown) attached to the fish 206. However, that first light pulse 304a would contain insufficient energy to kill a same parasite on a fish that is located at a similar position within the marine enclosure 208 such as illustrated in panel view at a second time period t₂ due to increased turbidity that absorbs more of the laser pulse energy before it reaches the parasite.

As discussed above, the data sets 212 including the image data set 212a and/or the environmental data set 212b are provided as input to one or more trained models 214 (e.g., a first trained model 214a for a first use case and at least a second trained model 214b for a second use case). In various embodiments, the first trained model 214a is trained to learn or identify a combination of intrinsic operating parameters for laser system 232 that enables administering of a laser pulse with sufficient energy for killing a first species of parasites for the first use case. In various embodiments, the trained models 214 include an output function representing learned laser operating parameters. Such trained models 214 may be utilized by, for example, the laser system controller 218 to dynamically reconfigure the intrinsic operating parameters of the laser system 232 for administering of a laser pulse with sufficient energy for killing a first species of parasites for the first use case.

Accordingly, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide a second light pulse 304b with sufficient energy for killing a first species of parasites for the first use case and further under turbid water conditions. Subsequently, as illustrated in panel view 300b, the laser system controller 218 configures the laser system 232 according to the determined second set of intrinsic operating parameters 302b such that one or more intrinsic operating parameters are changed relative to the first set of intrinsic operating parameters 302a for a second time period t₂.

In general, the second time period t₂ includes any time interval subsequent to that of the first time period t₁ and may be of any time duration. Thus, in some embodiments, the laser system 232 reconfiguration described herein with respect to FIGS. 2 and 3 may be performed on a periodic basis in accordance with a predetermined schedule. In other embodiments, the prevailing conditions of the environment 204 may be continuously monitored such that the laser system 232 is dynamically reconfigured in close to real-time as appropriate for particular use cases and in response to data represented within data sets 212.

Accordingly, in various embodiments, the processing system 210 dynamically reconfigures intrinsic operating parameters without modifying extrinsic operating parameters (although extrinsic camera parameters may be taken into account during analysis and processing of data sets 212 by the trained models). In other embodiments, the processing system 210 changes a pose of the laser system 232 without physically repositioning (e.g., translational movement within the environment 204) the sensor system away from its three-dimensional position within the marine enclosure 208. For example, in some embodiments, the processing system 210 may reconfigure the pose (not shown) by changing the external orientation (e.g., rotational movement of the device housing about one or more axes) of the laser system 232 relative to the environment 204. The dynamic reconfiguration of intrinsic operating parameters is particularly beneficial for stationary laser systems 232 without repositioning capabilities and/or for reducing disadvantages associated with physically repositioning sensors. In this manner, the efficacy of laser system operations for parasite control is improved in underwater farming environments 204 that are generally not controlled environments in which environmental conditions or underwater object behavior may be manually adjusted easily to create improved conditions for parasite.

It should be recognized that FIG. 3 is described primarily in the context of dynamic reconfiguration of laser system intrinsic parameters based on the underwater object parameter of fish position and water turbidity within the water column for ease of illustration and description. However, those skilled in the art will recognize that the image sensors for FIGS. 2 and 3 may be dynamically reconfigured based on data indicative of any number of underwater object parameters and/or environmental parameters. It should further be recognized that although FIG. 3 is described in the specific context of a laser, the one or more systems of FIG. 3 may include any number of and any combination of various image/environmental sensors and/or various optical light sources without departing from the scope of this disclosure.

Additionally, although dynamic laser operating parameter reconfiguration is described with respect to FIGS. 2 and 3 primarily in the context of below-water image sensors and below-water environmental sensors, sensor data may be collected by any of a variety of imaging and non-imaging sensors. By way of non-limiting examples, in various embodiments, the sensor systems may include various sensors local to the site at which the fish are located (e.g., underwater telemetry devices and sensors), sensors remote to the fish site (e.g., satellite-based weather sensors such as scanning radiometers), various environmental monitoring sensors, active sensors (e.g., active sonar), passive sensors (e.g., passive acoustic microphone arrays), echo sounders, photo-sensors, ambient light detectors, accelerometers for measuring wave properties, salinity sensors, thermal sensors, infrared sensors, chemical detectors, temperature gauges, or any other sensor configured to measure data that would have an influence on feeding appetite. It should be further recognized that, in various embodiments, the sensor systems utilized herein are not limited to below-water sensors and may include combinations of a plurality of sensors at different locations. It should also be recognized that, in various embodiments, the sensor systems utilized herein are not limited to single sensor-type configurations. For example, in various embodiments, the sensor systems may include two different sensor systems positioned at different locations (e.g., under water and above water) and/or a plurality of differing environmental sensors.

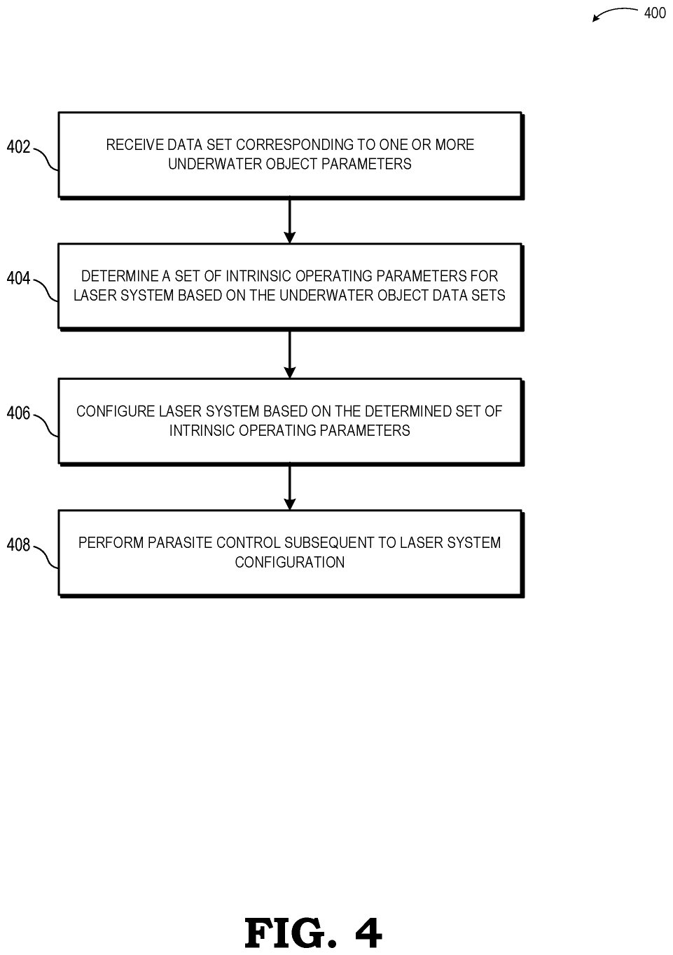

Referring now to FIG. 4, illustrated is a flow diagram of a method 400 for implementing dynamic reconfiguration of laser system operating parameters in accordance with some embodiments. For ease of illustration and description, the method 400 is described below with reference to and in an example context of the systems 100 and 200 of FIG. 1 and FIG. 2, respectively. However, the method 400 is not limited to these example contexts, but instead may be employed for any of a variety of possible system configurations using the guidelines provided herein.

The method begins at block 402 with the receipt by a processing system of data indicative of one or more underwater object parameters corresponding to one or more underwater objects within a marine enclosure. In various embodiments, the operations of block 402 include providing one or more sensor data sets via a wireless or wired communications link to a processing system for model training and subsequent use as input into trained models. For example, in the context of FIG. 1, the sensor systems 102 communicate at least the first sensor data set 112a and the second sensor data set 112b to the processing system 110 for storage, processing, and the like.

As illustrated in FIG. 1, the trained models 114 are executed locally using the same processing system 110 at which the first sensor data set 112a is stored. Accordingly, the first sensor data set 112a may be so provided to the trained models 114 by transmitting one or more data structures to processors 110 via a wireless or wired link (e.g., communications bus) for processing. It should be noted that the first sensor data set 112a and the trained models 114 do not need to be stored and/or processed at the same device or system. Accordingly, in various embodiments, the providing of the first sensor data set 112a and its receipt by the trained model for the operations of block 402 may be implemented in any distributed computing configuration (e.g., such as amongst the processing system 110, network 120, remote platforms 122, external resources 124, and server 126 of FIG. 1).

In at least one embodiment, and with reference to FIG. 2, the first sensor data set includes data corresponding to image data set 212a includes image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). With respect to image data, the image data set 212a may also include camera images capturing measurements representative of the relative and/or absolute locations of individual fish of the population of fish 206 within the environment 204. Such image data may be indicative of one or more underwater object parameters corresponding to one or more underwater objects (e.g., fish 206) within a marine enclosure 208.

Further, in various embodiments described with reference to FIGS. 1-3, the operations of block 402 may also include receiving data indicative of one or more environmental conditions associated with the marine enclosure. As previously described, the processing system 110 receives one or more sensor data sets 112 (e.g., first sensor data set 112a and the environmental sensor data set 112b) and stores the sensor data sets 112 at the storage device 116 for processing. In various embodiments, the sensor data sets 112 include data indicative of one or more conditions at one or more locations at which their respective sensor systems 102 are positioned. For example, the environmental data set 212b includes environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosure 208. For example, in some embodiments, the environmental sensors of the second sensor system 202b includes an ambient light sensor or other photodetector configured to sense or otherwise measure an amount of ambient light present within the environment local to the sensor. In various embodiments, the environmental sensors of the second sensor system 202b includes a turbidity sensor configured to measure an amount of light scattered by suspended solids in the water. Turbidity is a measure of the degree to which water (or other liquids) changes in level of its transparency due to the presence of suspended particulates (e.g., by measuring an amount of light transmitted through the water). In general, the more total suspended particulates or solids in water, the higher the turbidity and therefore murkier the water appears.

The method 400 continues at block 404 with the determination of a set of intrinsic operating parameters for a laser system at a position within the marine enclosure based at least in part on the data indicative of one or more underwater object parameters. With respect to FIGS. 2-3, in various embodiments, image data (which in various embodiments includes at least a subset of image data captured by one or more cameras of the first image sensor system 202a) and environmental data (which in various embodiments includes at least a subset of environmental data captured by one or more environmental sensors of the second sensor system 202b) is provided as training data to generate trained models 214 using machine learning techniques and neural networks.

Dynamic conditions, such as a change in the environment 204 around the first image sensor system 202a and/or the second sensor system 202b, impact the operations and accuracy of laser system 232 operations. In various embodiments, machine learning techniques may be used to determine various relationships between training images and the contextual image data to learn or identify relationships (e.g., as embodied in the trained models 214) between image data and laser operating parameters associated with sufficient energy output for killing a parasites. In various embodiments, the trained models 214 include an output function representing learned laser operating parameters.

In various embodiments, the first trained model 214a may be trained to learn or identify a combination of intrinsic operating parameters for the laser system 232 that enables killing of a first species of parasites under various underwater object parameters and environmental conditions. Similarly, the second trained model 214b may be trained to learn or identify a combination of intrinsic operating parameters for the laser system 232 that enables killing of a second species of parasites under various underwater object parameters and environmental conditions.

Referring now to FIGS. 2 and 3, in panel view 300a, a fish 206 is positioned within the marine enclosure 208 at a first time period t₁ at which the water is relatively clear of suspended particulates (e.g., as determined by environmental sensors 202b including a turbidity sensor). In panel view 300a, the laser system 232 is configured to operate according to a first set of intrinsic operating parameters 302a such that a first light pulse 304a emitted by the laser system 232 is sufficient to kill a parasite (not shown) attached to the fish 206. However, that first light pulse 304a would contain insufficient energy to kill a same parasite on a fish that is located at a similar position within the marine enclosure 208 such as illustrated in panel view at a second time period t₂ due to increased turbidity that absorbs more of the laser pulse energy before it reaches the parasite.

Accordingly, at block 404, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide a second light pulse 304b with sufficient energy for killing a first species of parasites for the first use case and further under turbid water conditions.

Subsequently, at block 406, the processing system configures the laser system according to the determined set of intrinsic operating parameters by changing at least one intrinsic operating parameter of the laser system in response to the data indicative of one or more underwater object parameters. For example, with respect to FIG. 3, after receiving input data indicative of underwater conditions within or proximate to the marine enclosure 208 (e.g., including image data set 212a and/or environmental data set 212b), the first trained model 214a determines and outputs a set of intrinsic operating parameters (as represented by the second set of intrinsic operating parameters 302b in FIG. 3) that is determined to provide a second light pulse 304b with sufficient energy for killing a first species of parasites for the first use case and further under turbid water conditions. The laser system controller 218 then configures the laser system 232 according to the determined second set of intrinsic operating parameters 302b such that one or more intrinsic operating parameters are changed relative to the first set of intrinsic operating parameters 302a for a second time period t₂.

At block 408, the processing system instructs the laser system 232 to direct a light pulse according to the determined set of intrinsic operating parameters towards a parasite within the marine enclosure in response to re-configuring the laser system 232 according to the determined sensor intrinsic operating parameters.

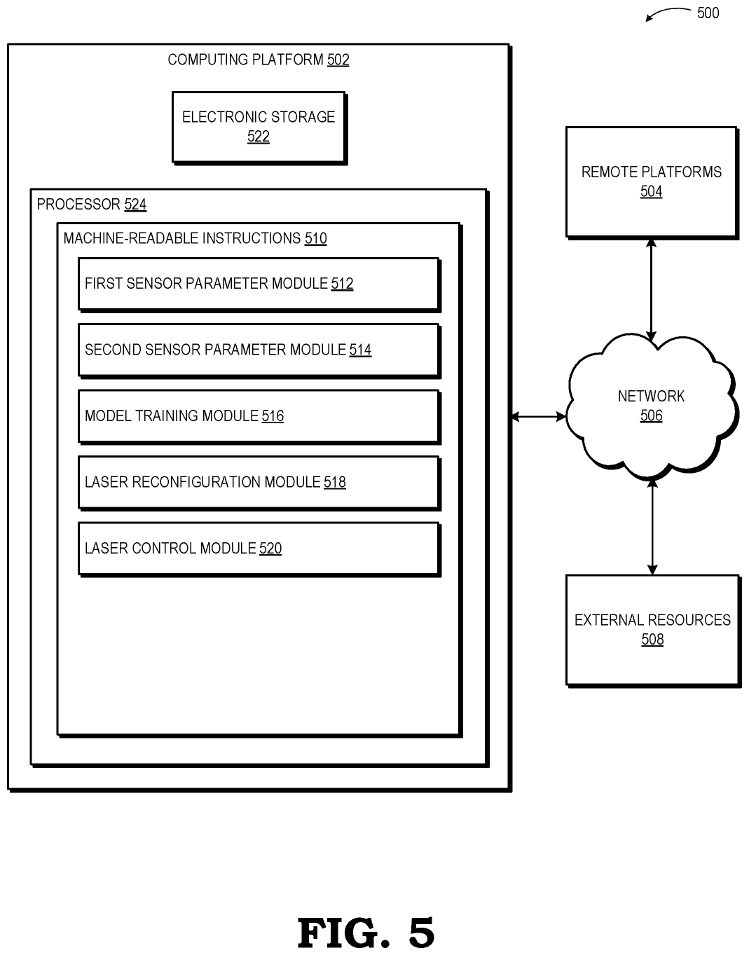

FIG. 5 is a block diagram illustrating a system 500 configured to provide dynamic laser system reconfiguration in accordance with some embodiments. In some embodiments, the system 500 includes one or more computing platforms 502. The computing platform(s) 502 may be configured to communicate with one or more remote platforms 504 according to a client/server architecture, a peer-to-peer architecture, and/or other architectures via a network 506. Remote platform(s) 504 may be configured to communicate with other remote platforms via computing platform(s) 502 and/or according to a client/server architecture, a peer-to-peer architecture, and/or other architectures via the network 506. Users may access system 500 via remote platform(s) 504. A given remote platform 504 may include one or more processors configured to execute computer program modules.

The computer program modules may be configured to enable an expert or user associated with the given remote platform 504 to interface with system 500 and/or one or more external resource(s) 508, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

In some implementations, the computing platform(s) 502, remote platform(s) 504, and/or one or more external resource(s) 506 may be operatively linked via one or more electronic communication links. For example, such electronic communication links may be established, at least in part, via a network 506 such as the Internet and/or other networks. It will be appreciated that this is not intended to be limiting, and that the scope of this disclosure includes implementations in which computing platform(s) 502, remote platform(s) 504, and/or one or more external resource(s) 508 may be operatively linked via some other communication media. External resource(s) 508 may include sources of information outside of system 500, external entities participating with system 500, and/or other resources. In some implementations, some or all of the functionality attributed herein to external resources 508 may be provided by resources included in system 500.

In various embodiments, the computing platform(s) 502 are configured by machine-readable instructions 510 including one or more instruction modules. In some embodiments, the instruction modules include computer program modules for implementing the various operations discussed herein (such as the operations previously discussed with respect to FIG. 4).

For purposes of reference, the instruction modules include one or more of a first sensor parameter module 512, a second sensor parameter module 514, a model training module 516, a laser reconfiguration module 518, and a laser control module 520. Each of these modules may be implemented as one or more separate software programs, or one or more of these modules may be implemented in the same software program or set of software programs. Moreover, while referenced as separate modules based on their overall functionality, it will be appreciated that the functionality ascribed to any given model may be distributed over more than one software program. For example, one software program may handle a subset of the functionality of the first sensor parameter module 512 while another software program handles another subset of the functionality of the second sensor parameter module 514.

In various embodiments, the first sensor parameter module 512 generally represents executable instructions configured to receive a first sensor parameter data set. With reference to FIGS. 1-4, in various embodiments, the first sensor parameter module 512 receives sensor data including the first sensor data set via a wireless or wired communications link for storage, further processing, and/or distribution to other modules of the system 500. For example, in the context of FIG. 2, the sensor system 202 communicate at least the first image data set 212a including image data representing any image-related value or other measurable factor/characteristic that is representative of at least a portion of a data set that describes the presence (or absence), abundance, distribution, size, and/or behavior of underwater objects (e.g., a population of fish 206 as illustrated in FIG. 2). In various embodiments, such first sensor parameter data sets may be processed by the first sensor parameter module 512 to format or package the data set for use by, for example, training or as input into machine-learning models.

In various embodiments, the second sensor parameter module 514 generally represents executable instructions configured to receive a second sensor parameter data set. With reference to FIGS. 1-4, in various embodiments, the second sensor parameter module 514 receives sensor data including the second sensor parameter data set via a wireless or wired communications link for storage, further processing, and/or distribution to other modules of the system 500. For example, in the context of FIGS. 2 and 3, the sensor systems 202b, 402b communicate at least the environmental data set 212b, 412b including environmental data indicating environmental conditions such as, for example, an ambient light level, an amount of dissolved oxygen in water, a direction of current, a strength of current, a salinity level, a water turbidity, a topology of a location, a weather forecast, and any other value or measurable factor/characteristic that is representative of environmental conditions proximate to the marine enclosures 208.

In various embodiments, the first model training module 516 generally represents executable instructions configured to receive at least a subset of the sensor parameter data sets from the sensor parameter modules 512, 514 and generate a trained model for a first use case. With reference to FIGS. 1-4, in various embodiments, the first model training module 516 receives one or more data sets embodying parameters related to underwater object parameters and environmental parameters that may influence the efficacy of laser system operations. For example, in the context of FIG. 2, the first model training module 516 receives one or more of more data sets 212 (e.g., image data set 212a and environmental data set 212b) and applies various machine learning techniques to determine various relationships between training images and the contextual image data to learn or identify relationships (e.g., as embodied in the trained models 214) between image data and laser operating parameters associated with outputting sufficient energy for killing a first species of parasites.

For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more laser operating parameters. In particular, the first model training module 516 generates a first trained model 214a for a first use case. In various embodiments, the first trained model 214a may be trained to learn or identify a combination of intrinsic operating parameters for the laser system 232 that enables laser system output of sufficient energy for killing a first species of parasites for the first use case, such use cases having been described in more detail above.

In various embodiments, the second model training module 518 generally represents executable instructions configured to receive at least a subset of the sensor parameter data sets from the sensor parameter modules 512, 514 and generate a trained model for a second use case. With reference to FIGS. 1-4, in various embodiments, the second model training module 518 receives one or more data sets embodying parameters related to underwater object parameters and environmental parameters that may influence the efficacy of laser system operations. For example, in the context of FIGS. 2 and 3, the second model training module 518 receives one or more of more data sets 212 (e.g., image data set 212a and environmental data set 212b) and applies various machine learning techniques to determine various relationships between training images and the contextual image data to learn or identify relationships (e.g., as embodied in the trained models 214) between image data and laser operating parameters associated with outputting sufficient energy for killing a second species of parasites.

For example, such learned relationships may include a learned function between underwater object parameters (e.g., physical location of fish 206 within the marine enclosure 208 such as represented within image data set 212a), environmental parameters (e.g., the turbidity of a liquid medium such as represented within environmental data set 212b), one or more image labels/annotations, image metadata, and other contextual image data to one or more sensor operating parameters. In particular, the second model training module 518 generates a second trained model 214b for a second use case. In various embodiments, the second trained model 214b may be trained to learn or identify a combination of intrinsic operating parameters for the laser system 232 that enables laser system output of sufficient energy for killing a second species of parasites for the second use case, such use cases having been described in more detail above.

In various embodiments, the laser control module 520 generally represents executable instructions configured to instruct the laser system according to the determined laser intrinsic operating parameters as output by the trained models of the first model training module 516 and the second model training module 518. For example, in the context of FIGS. 2 and 3, the laser control module 520 receives a set of intrinsic operating parameters (as represented by the second set of intrinsic operating parameters 302b in FIG. 3) that is determined to provide laser system output of sufficient energy for killing a first species of parasites for the first use case. Subsequently, the laser control module 520 configures the laser system 232 according to the determined second set of intrinsic operating parameters 302b such that one or more intrinsic operating parameters are changed relative to the first set of intrinsic operating parameters 302a for a second time period t₂. Additionally, the laser control module 520 instructs the laser system 232 to direct a light pulse according to the determined set of intrinsic operating parameters towards a parasite within the marine enclosure in response to re-configuring the laser system 232 according to the determined sensor intrinsic operating parameters.

The system 500 also includes an electronic storage 522 including non-transitory storage media that electronically stores information. The electronic storage media of electronic storage 522 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 522 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 522 may include one or more virtual storage resources (e.g., cloud storage, a virtual private network, and/or other virtual storage resources). Electronic storage 522 may store software algorithms, information determined by processor(s) 524, information received from computing platform(s) 502, information received from remote platform(s) 504, and/or other information that enables computing platform(s) 502 to function as described herein.

Processor(s) 524 may be configured to provide information processing capabilities in computing platform(s) 502. As such, processor(s) 524 may include one or more of a digital processor, an analog processor, a digital circuit designed to process information, an analog circuit designed to process information, a state machine, and/or other mechanisms for electronically processing information. Although processor(s) 524 is shown in FIG. 5 as a single entity, this is for illustrative purposes only. In some implementations, processor(s) 524 may include a plurality of processing units. These processing units may be physically located within the same device, or processor(s) 524 may represent processing functionality of a plurality of devices operating in coordination. Processor(s) 524 may be configured to execute modules 512, 514, 516, 518, and/or 520, and/or other modules. Processor(s) 524 may be configured to execute modules 512, 514, 516, 518, and/or 520, and/or other modules by software; hardware; firmware; some combination of software, hardware, and/or firmware; and/or other mechanisms for configuring processing capabilities on processor(s) 524. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 512, 514, 516, 518, and/or 520 are illustrated in FIG. 5 as being implemented within a single processing unit, in implementations in which processor(s) 524 includes multiple processing units, one or more of modules 512, 514, 516, 518, and/or 520 may be implemented remotely from the other modules. The description of the functionality provided by the different modules 512, 514, 516, 518, and/or 520 described below is for illustrative purposes, and is not intended to be limiting, as any of modules 512, 514, 516, 518, and/or 520 may provide more or less functionality than is described. For example, one or more of modules 512, 514, 516, 518, and/or 520 may be eliminated, and some or all of its functionality may be provided by other ones of modules 512, 514, 516, 518, and/or 520. As another example, processor(s) 524 may be configured to execute one or more additional modules that may perform some or all of the functionality attributed below to one of modules 512, 514, 516, 518, and/or 520.

Although primarily discussed here in the context of aquaculture as it relates to the generation of sensor data and laser-based parasite control with respect to fish 106, those skilled in the art will recognize that the techniques described herein may be applied to any aquatic, aquaculture species such as shellfish, crustaceans, bivalves, finfish, and the like without departing from the scope of this disclosure. Further, those skilled in the art will recognize that the techniques described herein may also be applied to dynamically reconfiguring laser systems for any husbandry animal that is reared in an environment in which laser systems are deployed (e.g., not in an underwater environment), and for which the laser systems will vary in efficacy depending on environmental conditions, population movement away from sensor capture areas, and the like.

Accordingly, as discussed herein, FIGS. 1-5 describe techniques that improve the precision and accuracy of laser systems by dynamically reconfiguring of laser system operating parameters during operations. In various embodiments, through the use of machine-learning techniques and neural networks, the systems described herein generate learned models that are unique to one or more intended use cases corresponding to different applications or activities at a farm site. Based on sensor data, the systems may use observed conditions at the farm sites to respond to environmental conditions/fish behavior relative to the laser systems and adjust laser system intrinsic operating parameters so that laser system operations are effective across various conditions and species without requiring physical repositioning of sensors.

The above-noted aspects and implementations further described in this specification may offer several advantages, including providing an efficient manner for automated and dynamic monitoring of fish to improve the results of aquaculture operations including parasite control. Further, by determining a proper fatal dose of light energy without under- or over-dosing, dynamic laser system reconfiguration improves energy efficiency by reducing an amount of instances in which a parasite needs to be re-lasered after previously receiving a non-lethal dose and/or delivering more energy than was needed to provide a lethal dose.

In some embodiments, certain aspects of the techniques described above may implemented by one or more processors of a processing system executing software. The software includes one or more sets of executable instructions stored or otherwise tangibly embodied on a non-transitory computer readable storage medium. A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments, meaning that the particular feature, function, structure, or characteristic being described is included in at least one embodiment of the techniques and concepts discussed herein. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Further, although the concepts have been described herein with reference to various embodiments, references to embodiments do not necessarily all refer to the same embodiment. Similarly, the embodiments referred to herein also are not necessarily mutually exclusive.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving, at an electronic device, data indicative of one or more underwater object parameters corresponding to one or more underwater objects within a marine enclosure;
determining, by the electronic device, a set of intrinsic operating parameters for a laser system at a position within the marine enclosure based at least in part on the data indicative of one or more underwater object parameters; and
configuring, by the electronic device, the laser system according to the determined set of intrinsic operating parameters by changing at least one intrinsic operating parameter of the laser system in response to the data indicative of one or more underwater object parameters.

2. The method of claim 1, wherein configuring the laser system according to the determined set of intrinsic operating parameters further comprises:
changing the at least one intrinsic operating parameter of the laser system without physically repositioning the laser system away from the position within the marine enclosure.

3. The method of claim 2, wherein changing the at least one parameter of the laser system further comprises:
changing a pose of the laser system without physically repositioning the laser system away from the position within the marine enclosure.

4. The method of claim 1, wherein receiving data indicative of one or more underwater object parameters comprises one or more of:
receiving data indicating a schooling behavior of fish;
receiving data indicating a swimming behavior of fish;
receiving data corresponding to a physical location of the one or more underwater objects;
receiving data corresponding to an identification of an individual fish; and
receiving data indicating a distance of the one or more underwater objects from the laser system.

5. The method of claim 1, further comprising:
receiving, at the electronic device, data indicative of one or more environmental conditions associated with the marine enclosure; and
determining, by the electronic device, the set of intrinsic operating parameters for the laser system based at least in part on the data indicative of one or more environmental conditions.

6. The method of claim 1, wherein changing the at least one intrinsic operating parameter of the laser system comprises one or more of:
changing a wavelength of light emitted from the laser system;
changing a pulse width duration of laser pulses from the laser system;
changing a laser power corresponding to energy output from the laser system;
changing a laser beam radius;
changing a focal spot size;
changing a focal length; and
changing a laser depth of focus.

7. The method of claim 1, further comprising:
instructing the laser system to direct a light pulse according to the determined set of intrinsic operating parameters towards a parasite within the marine enclosure.

8. A non-transitory computer readable medium embodying a set of executable instructions, the set of executable instructions to manipulate at least one processor to:
receive, at an electronic device, data indicative of one or more underwater object parameters corresponding to one or more underwater objects within a marine enclosure;
determine, by the electronic device, a set of intrinsic operating parameters for a laser system at a position within the marine enclosure based at least in part on the data indicative of one or more underwater object parameters; and
configure, by the electronic device, the laser system according to the determined set of intrinsic operating parameters by changing at least one intrinsic operating parameter of the laser system in response to the data indicative of one or more underwater object parameters.

9. The non-transitory computer readable medium of claim 8, further embodying executable instructions to manipulate at least one processor to:
change the at least one intrinsic operating parameter of the laser system without physically repositioning the laser system away from the position within the marine enclosure.

10. The non-transitory computer readable medium of claim 9, further embodying executable instructions to manipulate at least one processor to:
change a pose of the laser system without physically repositioning the laser system away from the position within the marine enclosure.

11. The non-transitory computer readable medium of claim 8, further embodying executable instructions to manipulate at least one processor to:
receive data indicating one or more of a schooling behavior of fish, a swimming behavior of fish, a physical location of the one or more underwater objects, an identification of an individual fish, and a distance of the one or more underwater objects from the laser system.

12. The non-transitory computer readable medium of claim 8, further embodying executable instructions to manipulate at least one processor to:
receive, at the electronic device, data indicative of one or more environmental conditions associated with the marine enclosure; and
determine, by the electronic device, the set of intrinsic operating parameters for the laser system based at least in part on the data indicative of one or more environmental conditions.

13. The non-transitory computer readable medium of claim 8, further embodying executable instructions to manipulate at least one processor to:
change one or more intrinsic operating parameters including a wavelength of light emitted from the laser system, a pulse width duration of laser pulses from the laser system, a laser power corresponding to energy output from the laser system, a laser beam radius, a focal spot size, a focal length, and a laser depth of focus.

14. The non-transitory computer readable medium of claim 8, further embodying executable instructions to manipulate at least one processor to:
instruct the laser system to direct a light pulse according to the determined set of intrinsic operating parameters towards a parasite within the marine enclosure.

15. A system, comprising:
a set of one or more sensors configured to capture a set of data indicative of one or more underwater object parameters corresponding to one or more underwater objects within a marine enclosure;
a digital storage medium, encoding instructions executable by a computing device;
a processor, communicably coupled to the digital storage medium, configured to execute the instructions, wherein the instructions are configured to:
determine, by the electronic device, a set of intrinsic operating parameters for a laser system at a position within the marine enclosure based at least in part on the data indicative of one or more underwater object parameters; and
configure, by the electronic device, the laser system according to the determined set of intrinsic operating parameters by changing at least one intrinsic operating parameter of the laser system in response to the data indicative of one or more underwater object parameters.

16. The system of claim 15, wherein the processor is further configured to:
change the at least one intrinsic operating parameter of the laser system without physically repositioning the laser system away from the position within the marine enclosure.

17. The system of claim 16, wherein the processor is further configured to:
change a pose of the laser system without physically repositioning the laser system away from the position within the marine enclosure.

18. The system of claim 15, wherein the processor is further configured to:
receive, data indicative of one or more environmental conditions associated with the marine enclosure; and
determine the set of intrinsic operating parameters for the laser system based at least in part on the data indicative of one or more environmental conditions.

19. The system of claim 15, wherein the processor is further configured to:
change one or more intrinsic operating parameters including a wavelength of light emitted from the laser system, a pulse width duration of laser pulses from the laser system, a laser power corresponding to energy output from the laser system, a laser beam radius, a focal spot size, a focal length, and a laser depth of focus.

20. The system of claim 15, wherein the processor is further configured to:
instruct the laser system to direct a light pulse according to the determined set of intrinsic operating parameters towards a parasite within the marine enclosure.
